(19) United States
(12) Patent Application Publication
(10) Pub. No.: US 2010/0322313 A1
(43) Pub. Date: Dec. 23, 2010

(54) SYSTEM AND METHOD FOR ESTIMATING SUM OF ABSOLUTE DIFFERENCES

(75) Inventors: SHAO-WEN WANG, Tu-Cheng (TW); PI-JYE TSAUR, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/604,345

(22) Filed: Oct. 22, 2009

(30) Foreign Application Priority Data
Jun. 23, 2009 (CN) 200910303547.8

(51) Int. Cl. H04N 7/32

(52) U.S. Cl. 375/240.16; 375/240.12; 375/E07.243; 375/E07.104

(57) ABSTRACT

A system is disclosed for estimating a sum of absolute differences (SAD) between a macro block of a current frame and a candidate block of a reference block. The macro block includes a number of sub macro blocks of pixels. A number of sample pixels are selected from each of the number of sub macro blocks. A reference pixel corresponding to each of the sample pixels is found in the candidate block. The system obtains a sub SAD by multiplying an average of the absolute differences between pixel values of the selected pixels of each of the plurality of sub macro blocks and corresponding relative pixels of the candidate block by a corresponding pixel number. The SAD is obtained by adding all of the sub SADs together.

### BACKGROUND

1. Technical Field

The present disclosure relates to moving picture coding systems, and more particularly to a system and a method for estimating a sum of absolute differences (SAD).

2. Description of Related Art

Generally in moving picture coding, differences between a current frame and a reference frame, instead of all the information of each frame of the moving picture, are coded. Since temporally successive frames are often highly correlated, the differences may be very small, therefore, the moving picture can be compressed efficiently without processing all the information of the moving picture.

Intra and inter predictions are generally used in such moving picture coding to exploit temporal and spatial redundancy correspondingly for data compression. Motion estimations are needed in inter predictions. In motion estimations, the current frame may be divided into a plurality of macro blocks (MBs) of pixels. Each of the plurality of MBs is compared with candidate blocks in a search area of the reference frame to find a matched block in the candidate blocks. The moving picture can be reproduced by coding, decoding, and compensating motion vectors (MVs) between the plurality of MBs and the corresponding matched blocks in the reference frame.

An SAD is used to determine whether an MB and a candidate block match. A conventional method for calculating the SAD between the MB and the candidate block is expressed as:

$$SAD = {\sum }_{x = 0}^{M - 1} {\sum }_{y = 0}^{N - 1} \vert {f}_{t} ( x , y ) - {f}_{t - 1} ( x + j , y + k ) \vert ,$$

wherein M and N are respectively numbers of pixels along a horizontal axis and a longitudinal axis in each of the MB and the candidate block. A size of each of the MBs and the candidate block is expressed as M*N, (x, y) are coordinates of pixels of the MB (fₜ) in the current frame, (x+j, y+k) are coordinates of pixels of the candidate block (fₜ₋₁) in the reference frame. It is considered that the candidate block matches the MB when the SAD is minimum. This method is still troublesome because differences between all of the pixels of the MB and the corresponding pixels of the candidate block should be added together, and a complicated calculation is needed.

### BRIEF DESCRIPTION OF THE DRAWINGS

FIG. 1 is a block diagram of an embodiment of a system for estimating a sum of absolute differences, the system includes a block dividing module.

FIG. 2 is a schematic diagram of a macro block which is divided into sub macro blocks by the block dividing module of FIG. 1.

FIG. 3 is a schematic diagram of the macro block of FIG. 2.

FIG. 4 is a schematic diagram of the sub macro block of FIG. 2.

FIG. 5 is a schematic diagram of a search area corresponding to the macro block of FIG. 2.

FIG. 6 is a schematic diagram of a candidate block in the search area of FIG. 5.

FIG. 7 is a flowchart diagram of an embodiment of a method for estimating a sum of absolute differences between the macro block of FIG. 2 and the candidate block of FIG. 6.

### DETAILED DESCRIPTION

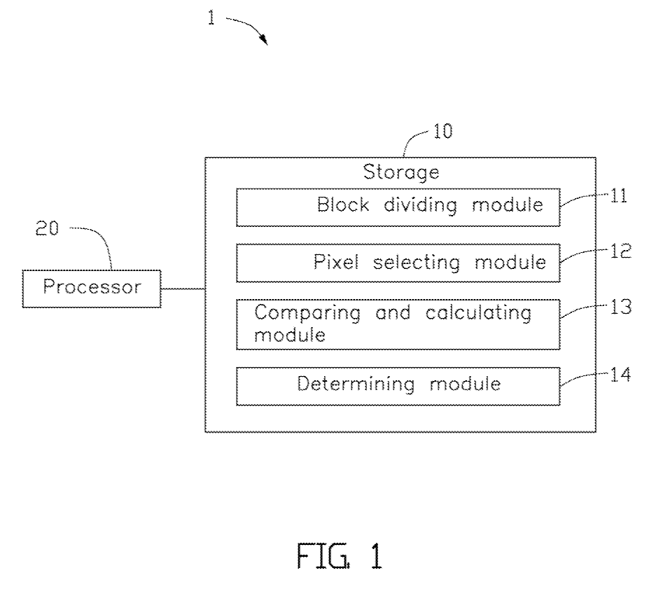

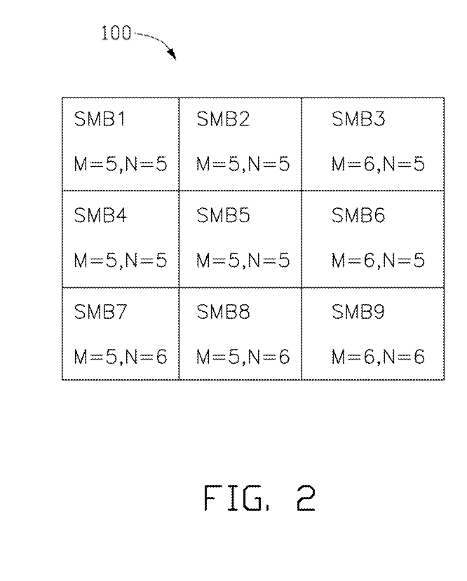

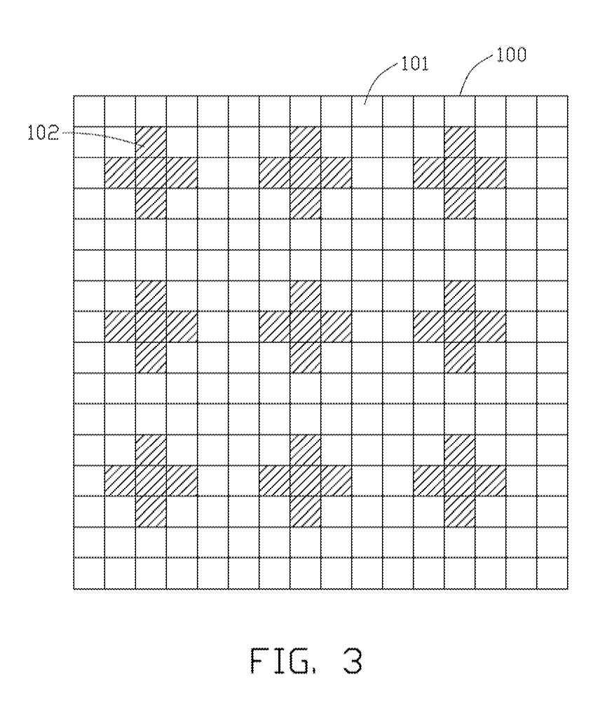

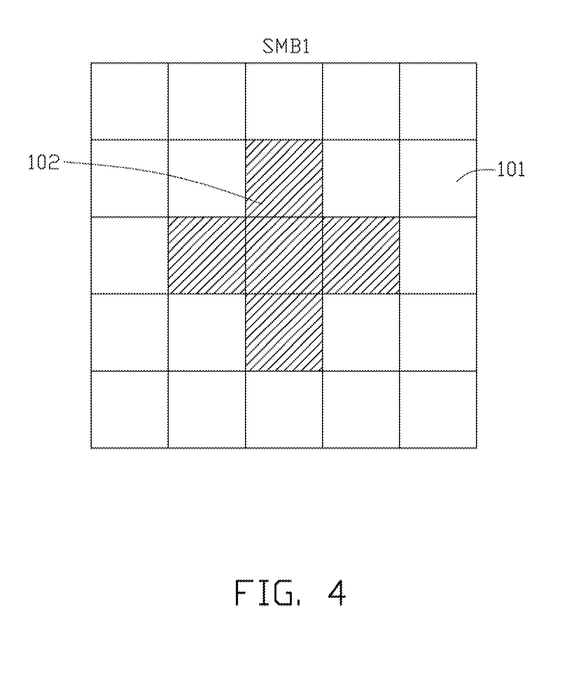

Referring to FIGS. 1-4, an embodiment of a system 1 includes a storage 10 and a processor 20. The storage 10 includes a block dividing module 11, a pixel selecting module 12, a comparing and calculating module 13, and a determining module 14. The block dividing module 11, pixel selecting module 12, comparing and calculating module 13, and determining module 14 may include one or more computerized instructions and are executed by the processor 20. The system 1 may be used when processing differences between a current frame (not shown) and a reference frame (not shown) during moving picture coding. The current frame and the reference frame may be two temporally successive frames in a video. The current frame includes a plurality of macro blocks. The system 1 is operable to estimate a sum of absolute differences (SAD) between each of the plurality macro blocks and a corresponding candidate block in a search area of the reference frame.

The block dividing module 11 divides each of the plurality of macro blocks 100 into a plurality of sub macro blocks of pixels. Each pixel has a pixel value representing an image characteristic. Take one of the plurality of macro blocks 100 for example, the macro block 100 includes 256 pixels 101 arrayed in 16 rows and 16 lines, and is divided into nine sub macro blocks SMB1-SMB9 by the block dividing module 11. Each of the sub macro blocks SMB1-SMB9 includes M*N pixels. M represents a number of the pixels along a horizontal axis in each of the sub macro blocks SMB1-SMB9. N represents a number of the pixels along a longitudinal axis in each of the sub macro blocks SMB1-SMB9. For example, in the sub macro block SMB1, both M and N are equal to 5, therefore, the sub macro block SMB1 includes 25 pixels. In this embodiment, each of the sub macro blocks SMB5, SMB6, and SMB7 includes 25 pixels. The macro block SMB4 includes 36 pixels. Each of the sub macro blocks SMB2, SMB3, SMB8, and SMB9 includes 30 pixels.

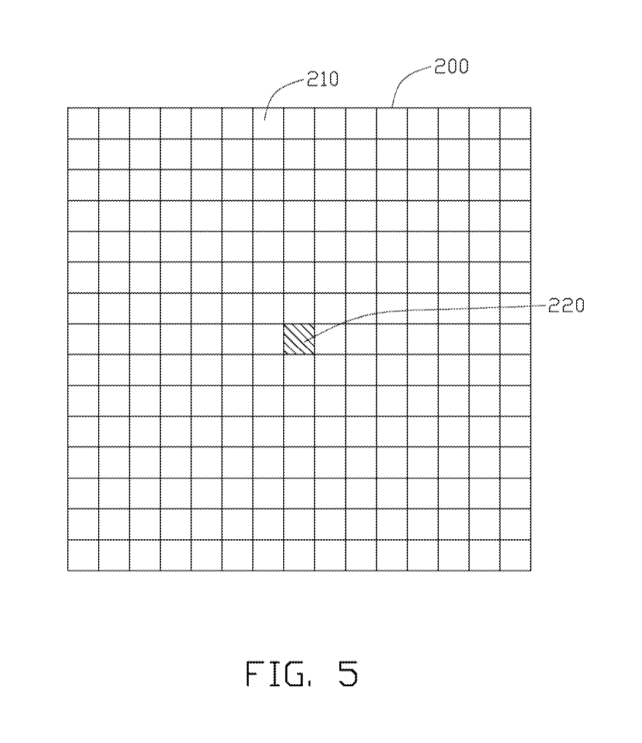

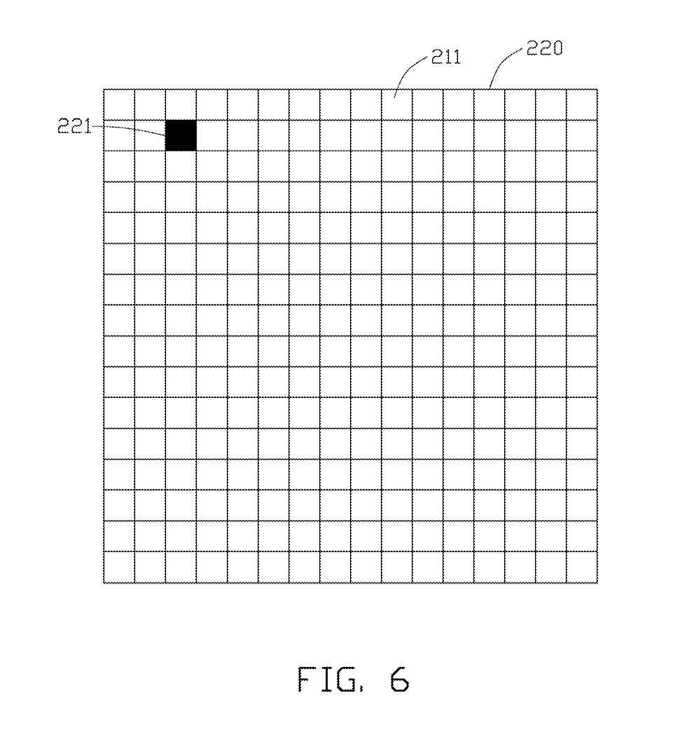

Referring to FIGS. 5, 6, the reference frame includes a plurality of search areas each corresponding to a macro block in the current frame. Each search area includes a plurality of candidate blocks. The plurality of candidate blocks and the corresponding macro block 100 are in the same size. In this embodiment, take a search area 200 which is corresponding to the macro block 100 for example. The search area 200 includes a plurality of candidate blocks 210 arrayed in (2X+1) rows and (2Y+1) lines. Each of the candidate blocks 210 includes 256 pixels 211 arrayed in 16 rows and 16 lines. In this embodiment, both X and Y are equal to 7, and the number of the plurality of candidate blocks 210 is 225.

One of the plurality of candidate blocks 210 which matches the macro block 100 may be found by comparing at least one of the plurality of candidate block 210 with the macro block 100 according to a predetermined sequence. For example, a candidate block 220, which is at the center of the search area 200, may be firstly compared with the micro block 100 to obtain a SAD of the macro block 100 relative to the candidate block 220. If the SAD is less than a predetermined value then it is accepted as a match of the macro block 100 and the candidate block 220. If the candidate block 220 does not match the macro block 100, the macro block 100 is compared with other candidate blocks 210 according to the predetermined sequence.

During estimation of the SAD between the macro block 100 and the candidate block 220, the pixel selecting module 12 selects a plurality of pixels from each of the sub macro blocks SMB1-SMB9 to be compared with each pixels of the candidate block 220. In this illustrated embodiment, the selected pixels are indicated by shadow, and function as sample pixels 102. For example, a pixel, which is at a center point of the macro block SMB1, and four pixels around the center point are selected to be the sample pixels 102. The value of each of the sample pixels 102 is compared with the value of each pixel of the candidate block 220 by the comparing and calculating module 13, as a result, a relative pixel that is most similar to the sample pixels 102 can be found in the candidate block 200. For example, it may be determined that a relative pixel 221 as illustrated in FIG. 6 is most similar to the sample pixel 102 located at the center of the sub macro block SMB1 after comparison of the value of the sample pixel 102 and each of the pixels of the candidate block 220.

The comparing and calculating module 13 obtains an absolute difference between the values of each of the sample pixels 102 and the corresponding relative pixel, and averages the absolute differences between the sample pixels 102 of each of the sub macro blocks SMB1-SMB9 and the corresponding relative pixels to obtain an average value. Each of the average values is multiplied by the number of the sample pixels 102 of a corresponding one of the sub macro blocks SMB1-SMB9 to obtain a sub SAD (SSAD). The SAD of the macro block 100 is determined by adding the SSADs of all of the sub macro blocks SMB1-SMB9 together by the comparing and calculating module 13.

The determining module 14 compares the SAD to the predetermined value. If the SAD is less than the predetermined value then it is accepted as a match of the macro block 100 and the candidate block 220. That is to say, a reference position of the macro block 100 is found in the search area 200 of the reference frame. The SAD is assigned to be zero when it is less than the predetermined value, representing that a motion estimation of the macro block 100 is finished, without comparing the macro block 100 to other candidate blocks 210 in the search area 200. If the SAD is equal to or greater than the predetermined value, the system 1 estimates a SAD between the macro block 100 and other candidate blocks 210, until a match of the macro block 100 and a candidate block 210 is accepted.

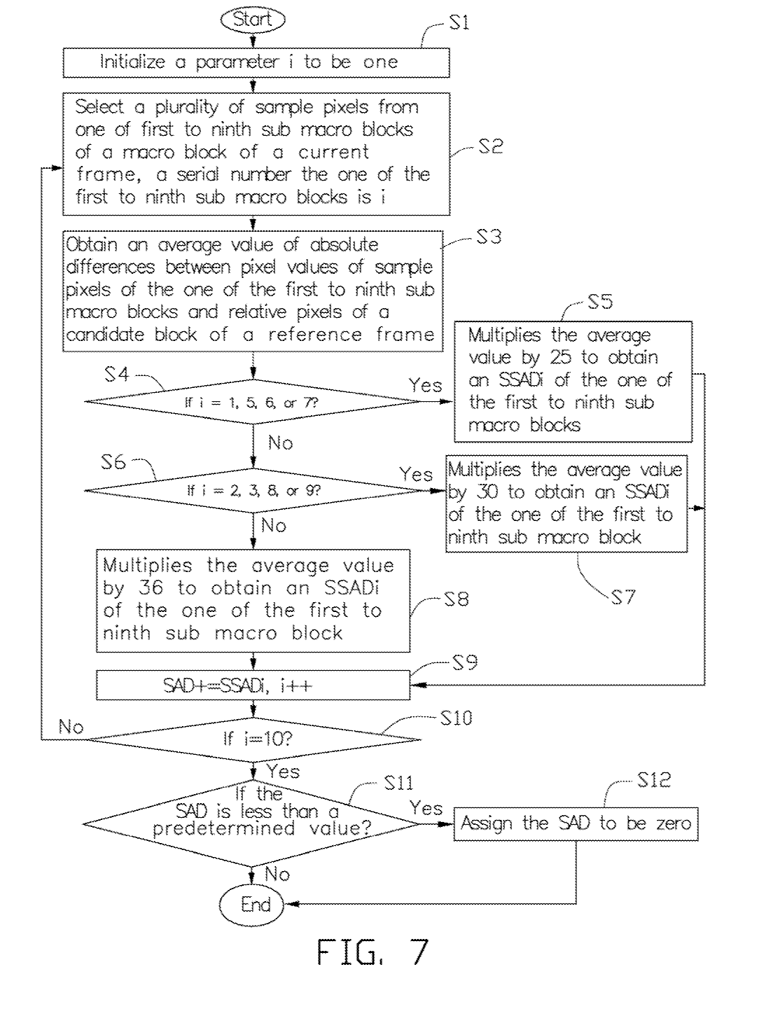

Referring to FIG. 7, an embodiment of a method for estimating an SAD includes the following steps.

In step S1, a parameter i is initialized to be one. The parameter i represents serial numbers of the sub macro blocks SMB1-SMB9. For example, the parameter i represents the second sub macro block SMB2 when it is equal to two.

In step S2, the pixel selecting module 12 selects a plurality of sample pixels 102 from pixels 101 of one of the sub macro blocks SMB1-SMB9, the serial number of the one of the sub macro blocks SMB1-SMB9 is i. In this embodiment, a pixel located at a center point of the one of the sub macro blocks SMB1-SMB9 and four pixels around the center point are selected.

In step S3, the comparing and calculating module 13 obtains the absolute difference between the pixel values of each sample pixel 102 of the one of the sub macro blocks SMB1-SMB9 and a corresponding relative pixel of a candidate block, such as the candidate block 220, and averages the absolute differences of the one of the sub macro blocks SMB1-SMB9 to obtain an average value.

In step S4, the processor 20 determines whether the parameter i is equal to 1, 5, 6, or 7. If the parameter i is equal to 1, 5, 6, or 7, step S5 as detailed below is executed, and step S9 is also executed. If the parameter i is not equal to 1, 5, 6, or 7, step S6 as detailed below is executed.

In step S5, the comparing and calculating module 13 multiplies the average value of the one of the sub macro blocks by 25 to obtain a sub SAD (SSAD) of the one of the sub macro blocks. In this step, the one of the sub macro blocks may be the sub macro block SMB1, SMB5, SMB6, or SMB7, each of which includes 25 pixels.

In step S6, the processor 20 determines whether the parameter i is equal to 2, 3, 8, or 9. If the parameter i is equal to 2, 3, 8, or 9, step S7 as detailed below is executed, and step S9 is also executed. If the parameter is not equal to 2, 3, 8, or 9, step S8 is executed.

In step S7, the comparing and calculating module 30 multiplies the average value of the one of the sub macro blocks by 30 to obtain the SSAD of the one of the sub macro blocks. In this step, the one of the sub macro blocks may be the sub macro block SMB2, SMB3, SMB8, or SMB9, each of which includes 30 pixels.

In step S8, the average value of the one of the sub macro blocks is multiplied by 36 to obtain the SSAD of the one of the sub macro blocks. In this step, the one of the sub macro blocks is the sub macro block SMB4, which includes 36 pixels.

In step S9, all of the obtained SSAD are added together to obtain a value of the SAD, and the parameter i is increased by 1.

In step S10, the processor 20 determines whether the parameter i is equal to 10. If the parameter i is not equal to 10, the procedure returns to step S2. If the parameter i is equal to 10, the procedure goes to step S11.

In step S11, the determining module 14 determines whether the SAD is less than the predetermined value. If the SAD is less than the predetermined value, the procedure goes to step S12. If the SAD is not less than the predetermined value, the procedure ends.

In step S12, the SAD is assigned to be zero.

In this embodiment, if the SAD is equal to or greater than the predetermined value, the comparison between the macro block 100 and the candidate block 220 is finished, and the macro block 100 is compared with another one of the candidate blocks 210 in the search area 200, until the SAD is less than the predetermined value.

According to above described steps S1-S12, the sub SAD of the macro block SMB1 is firstly obtained, and the SSADs of the macro blocks SMB1-SMB9 are obtained in sequence according to changes of the value of the parameter i.

A complicated estimation of the SAD is avoided since it is unnecessary to compare each of the pixels 101 in the macro block 100 with the pixels of the corresponding candidate block in the search area 200. A speed of the motion estimation of the macro block 100 can be increased because the SAD is compared with a predetermined value, if the SAD is less than the predetermined value, the motion estimation can be finished in advance. The system 1 can be used in any block based motion estimation. For example, the system 1 can be used in block based motion estimation of video compression technologies, such as H.264, and MPEG4 (moving picture experts group 4).

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A system for estimating a sum of absolute differences (SAD) between a macro block of pixels of a current frame and a candidate block of pixels of a reference frame, wherein pixel numbers of the macro block and the candidate block are the same, the macro block of pixels is divided into a plurality of sub macro blocks, the system comprising:
a processor; and
a storage device connected to the processor and a plurality of modules each of which stores one or more computerized instructions to be executed by the processor, wherein the plurality of modules comprises:
a pixel selecting module to select a plurality of pixels from each of the plurality of sub macro blocks; and
a comparing and calculating module to determine a pixel relative to each of the selected pixels in the candidate block by comparing pixel values of each of the selected pixels with each pixel of the candidate block, obtain an absolute difference between pixel values of each of the selected pixels and the corresponding relative pixel, average the obtained absolute differences between pixel values of the selected pixels of each of the plurality of sub macro blocks and the corresponding relative pixels to obtain an average value corresponding to each of the plurality of sub macro blocks, and multiply each of the average values by a number of pixels of a corresponding one of the plurality of sub macro blocks to obtain a sub SAD, and obtain the SAD by adding all of the sub SADs together.

2. The system of claim 1, further comprising a block dividing module to divide the macro block into the plurality of sub macro blocks.

3. The system of claim 1, wherein the macro block is divided into nine sub macro blocks arrayed in three rows and three lines.

4. A system for estimating a sum of absolute differences (SAD) between a macro block of a current frame and a candidate block of a reference frame, wherein the current frame and the reference frame are two temporally successive frames, and the macro block and the candidate block are in the same size, the macro block comprises a plurality of sub macro blocks of pixels, the system comprising:
a processor; and
a storage device connected to the processor and a plurality of modules each of which stores one or more computerized instructions to be executed by the processor, wherein the plurality of modules comprises:
a pixel selecting module to select part of pixels from each of the plurality of sub macro blocks of pixels;
a comparing and calculating module to determine a pixel relative to each of the selected pixels in the candidate block by comparing pixel values of each of the selected pixels with each pixel of the candidate block, obtain an absolute difference between pixel values of each of the selected pixels and the corresponding relative pixel, average the obtained absolute differences between pixel values of the selected pixels of each of the plurality of sub macro blocks and the corresponding relative pixels to obtain an average value corresponding to each of the plurality of sub macro blocks, and multiply each of the average values by the number of pixels of a corresponding one of the plurality of sub macro blocks to obtain a sub SAD, and obtain the SAD by adding all of the sub SADs together; and
a determining module to determine whether the SAD is less than a predetermined value, wherein the SAD is assigned to be zero in response to the SAD being less than the predetermined value, representing a match of the macro block and the candidate block.

5. A method for estimating a sum of absolute differences (SAD) between a macro block of pixels of a current frame and a candidate block of pixels of a reference frame during a motion estimation of the macro block, wherein the macro block is divided into a plurality of sub macro blocks, the method comprising:
selecting a plurality of sample pixels from each of the plurality of sub macro blocks by a pixel selecting module;
determining a reference pixel corresponding to each of the plurality of sample pixels in the candidate block by a comparing and calculating module;
obtaining an absolute difference between each of the plurality of sample pixels and the corresponding reference pixel;
averaging the obtained absolute differences relative to the plurality of sample pixels of each of the plurality of sub macro blocks to obtain an average value corresponding to each of the plurality of sub macro blocks, and multiplying each of the average values by a number of pixels of an corresponding one of the plurality of sub macro blocks to obtain a sub SAD of each of the plurality of sub macro blocks;
obtaining the SAD by adding the sub SADs of the plurality of sub macro blocks together; and
determining whether the SAD is less than a predetermined value by a determining module, if the SAD is less than the predetermined value, the motion estimation of the macro block is ended.

6. The method of claim 5, wherein the performing of the method is ended by assigning the SAD to be zero.

7. The method of claim 5, wherein the reference pixel is determined by comparing pixel values of each of the sample pixels with each pixel of the candidate block, the pixel value of the reference pixel is most close to the corresponding sample pixel.

8. The method of claim 5, wherein the sub SADs of the plurality of sub macro blocks are obtained in sequence.
